(19) United States
(12) Patent Application Publication
(10) Pub. No.: US 2026/0075610 A1
(43) Pub. Date: Mar. 12, 2026

(54) PHYSICAL UPLINK CONTROL CHANNEL (PUCCH) FOR SUBBAND FULL DUPLEX OPERATION

(71) Applicant: Telefonaktiebolaget LM Ericsson (publ), Stockholm (SE)

(72) Inventors: Stephen GRANT, Pleasanton, CA (US); Jung-Fu CHENG, Fremont, CA (US)

(21) Appl. No.: 19/101,164

(22) PCT Filed: Aug. 11, 2023
(86) PCT No.: PCT/SE2023/050815

§ 371 Date: Feb. 4, 2025

Related U.S. Application Data
(60) Provisional application No. 63/397,647, filed on Aug. 12, 2022.

(51) Int. Cl. H04W 72/21; H04L 5/14

(52) U.S. Cl. CPC H04W 72/21; H04L 5/14

(57) ABSTRACT

A method, system and apparatus are disclosed. According to one aspect of the present disclosure, a wireless device is provided. The wireless device is configured to receive control signaling for a physical uplink control channel, PUCCH, transmission. Wireless device is configured to perform the PUCCH transmission based on the control signaling, the PUCCH transmission spanning a plurality of slots, the plurality of slots including at least one slot containing at least one UL-only symbol and at least one slot containing at least one subband full duplex, SBFD, symbol, and the PUCCH transmission spans the at least one UL-only symbol and the at least one SBFD symbol.

### TECHNICAL FIELD

The present disclosure relates to wireless communications, and in particular, to enabling operation across slots in which the number of available uplink resources in the frequency domain is different in different slots.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WDs), as well as communication between network nodes and between wireless devices. Sixth Generation (6G) wireless communication systems are also under development.

3GPP NR is being designed to provide service for multiple use cases such as enhanced mobile broadband (eMBB), ultra-reliable and low latency communication (URLLC), and machine type communication (MTC). Each of these services has different technical requirements. For example, the general requirement for eMBB is high data rate with moderate latency and moderate coverage, while URLLC service requires a low latency and high reliability transmission but perhaps for moderate data rates.

One approach for low latency data transmission is shorter transmission time intervals. In NR, in addition to transmission in a slot, a mini-slot transmission is also allowed to reduce latency. A mini-slot may consist of any number of 1 to 14 Orthogonal Frequency Division Multiplexing (OFDM) symbols. It is noted that the concepts of slot and mini-slot are not specific to a specific service meaning that a mini-slot may be used for either eMBB, URLLC, or other services.

In 3GPP Release 15 (Rel-15) NR, a wireless device can be configured with up to four carrier bandwidth parts in the downlink with a single downlink carrier bandwidth part being active at a given time. A wireless device can be configured with up to four carrier bandwidth parts in the uplink with a single uplink carrier bandwidth part being active at a given time.

FIG. 1 is a diagram of an example radio resource. An 3GPP NR slot consists of several OFDM symbols, according to existing 3GPP agreements either 7 or 14 symbols (OFDM subcarrier spacing≤60 kHz) and 14 symbols (OFDM subcarrier spacing >60 KHz). FIG. 2 is an example showing a subframe with 14 OFDM symbols. In FIG. 2, T_s and T_symb denote the slot and OFDM symbol duration, respectively.

### FDD and TDD Systems

Transmission and reception from a node, e.g., network node and/or wireless device in a cellular system, can be multiplexed in the frequency domain or in the time domain (or combinations thereof). Frequency Division Duplex (FDD) as illustrated in the left hand panel of FIG. 3 implies that downlink and uplink transmission take place in different, sufficiently separated, frequency bands. Time Division Duplex (TDD), as illustrated in the right-hand panel of FIG. 3, implies that downlink and uplink transmission take place in different, non-overlapping time slots. Thus, TDD can operate in unpaired spectrum, whereas FDD may require paired spectrum.

Typically, the structure of the transmitted signal in a communication system is organized in the form of a frame structure. For example, NR uses ten equally-sized slots per radio frame, as illustrated in FIG. 4, for the case of 15 kHz subcarrier spacing.

In cases of FDD operation (upper part of FIG. 4), there are two carrier frequencies, one for uplink transmission (f_{UL}) and one for downlink transmission (f_{DL}). At least with respect to the wireless device in a cellular communication system, FDD can be either full duplex or half duplex. In the full duplex case, a wireless device can transmit and receive simultaneously, while in half-duplex operation, the wireless device cannot transmit and receive simultaneously (the network node is capable of simultaneous reception/transmission though, e.g., receiving from one wireless device while simultaneously transmitting to another wireless device). In LTE, a half-duplex wireless device is monitoring/receiving in the downlink except when explicitly being instructed to transmit in a certain subframe.

In cases of TDD operation (lower part of FIG. 4), there is only a single carrier frequency and uplink and downlink transmissions are always separated in time also on a cell basis. As the same carrier frequency is used for uplink and downlink transmission, both the base station and the mobile wireless devices need to switch from transmission to reception and vice versa. An aspect of most TDD systems is to provide the possibility for a sufficiently large guard time where neither downlink nor uplink transmissions occur. This may be required to avoid interference between uplink and downlink transmissions. For NR, this guard time is provided by special subframes, which are split into three parts: symbols for DL, a guard period (GP), and symbols for uplink. The remaining subframes are either allocated to uplink or downlink transmission.

In more detail, the following two information elements (IEs) are defined in existing 3GPP specifications. The TDD pattern is typically configured with at least the first IE and optionally the 2nd IE:
TDD-DL-UL-ConfigCommon (cell-specific)
TDD-DL-UL-ConfigDedicated (wireless device-specific)

The first IE is cell specific (common to all wireless device s) and is provided by broadcast signaling. It provides the number of slots in the TDD pattern via a reference subcarrier spacing and a periodicity such that the S-slot pattern repeats every S slots. This IE allows for very flexible configuration of the pattern characterized as follows:
A number of full downlink slots at the beginning of the pattern configured by the parameter nDownlinkSlots
A number of full uplink slots at the end of the pattern configured by the parameter nUplinkSlots
A number of downlink (‘D’) symbols following the full downlink slots configured by the parameter nDownlinkSymbols
A number of uplink (‘U’) symbols preceding the full downlink slots configured by the parameter nUplinkSlots
If there is a gap between the last downlink symbol and the first uplink symbol, then all symbols in the gap are characterized as flexible (‘F’). A symbol classified as ‘F’ can be used for downlink or uplink. A wireless device determines the direction in one of the following two ways:
   Detecting a DCI that schedules/triggers a DL signal/channel, e.g., PDSCH, CSI-RS or schedules/triggers an UL signal/channel, e.g., PUSCH, SRS, etc.
   By dedicated (wireless-device-specific) signaling of the IE TDD-DL-UL-ConfigDedicated. This parameter overrides some or all of the ‘F’ symbols in the pattern, thus providing a semi-static indication of whether a symbol is classified as ‘D’ or ‘U’
Optionally, a 2nd pattern that is concatenated to the first pattern can be configured as described above. If a 2nd pattern is configured, the constraint is that the sum of the periodicities of the two patterns may have to evenly divide by 20 ms.

FIG. 5 shows an example TDD DL/UL pattern including S=5 slots. TDD-DL-UL-ConfigCommon configures the cell-specific pattern, and TDD-DL-UL-ConfigDedicated (if provided) wireless-device-specifically configures the direction for some or all of the ‘F’ symbols in the cell-specific pattern. It includes three full ‘D’ slots, 1 full ‘U’ slot, with a mixed slot in between consistinag of 4 ‘D’ symbols and 3 ‘U’ symbols. The remaining 7 symbols in the mixed slot are classified as ‘F.’

Still referring to FIG. 5., if a wireless device is not configured with TDD-DL-UL-ConfigDedicated, then the pattern at the top of the diagram is what the wireless devices assumes to be configured. As described above, the network node can make use of the ‘F’ symbols flexibly, by scheduling/triggering either an uplink or a downlink signal/channel in a wireless device specific manner. This allows for dynamic behavior: the direction is not known to the wireless device a priori: rather, the direction becomes known once the wireless device detects a DCI scheduling/triggering a particular DL or UL signal/channel.

In contrast, the DL/UL direction for some or all of the ‘F’ symbols in a particular slot can be provided to the wireless device in a semi-static manner by radio resource control (RRC) configuring the wireless device with TDD-DL-UL-ConfigDedicated. The lower part of FIG. 5 shows three example configurations for overriding ‘F’ symbols in Slot 3. If the IE indicates ‘allDownlink’ or ‘allUplink’ for a particular slot (or slots), then all ‘F’ symbols in the slot are converted to either ‘D’ or ‘U,’ respectively. If the IE indicates ‘explicit,’ then a number of symbols at the beginning of the slot and/or a number of symbols at the end of the slot are indicated as ‘D’ and ‘U,’ respectively. In the example below; the first seven and the last five are indicated as ‘D’ and ‘U’, which converts some of the ‘F’ symbols (but not all in this example) to ‘D’ and ‘U.’

The behavior in the above is that the wireless-device-specific IE TDD-DL-UL-ConfigDedicated can only override (i.e., specify ‘D’ or ‘U’) for symbols that are configured as ‘F’ by the cell-specific IE TDD-DL-UL-ConfigCommon. In other words, a wireless device does not expect to have a ‘D’ symbol converted to ‘U’ or vice versa.

FIG. 6 shows three additional example TDD DL/UL patterns configured by TDD-DL-UL-ConfigCommon. In the first and second patterns, there are no ‘F’ symbols, hence according to current behavior in the Rel-17 specifications, the wireless device would not expect to be configured with TDD-DL-UL-ConfigDedicated. In the second pattern, all symbols in Slots 1, 2, and 3 are configured as ‘F;’ hence, the wireless device could be configured with TDD-DL-UL-ConfigDedicated to provide a direction (‘D’ or ‘U’) for any or all symbols in these three slots. Note that the current (Rel-17) specifications allow the dedicated configuration of the TDD pattern on a slot-specific basis. In other words, TDD-DL-UL-ConfigDedicated is not restricted to be the same in each slot where ‘F’ symbols are overridden.

### Subband Full Duplex

In a conventional TDD system, the entire carrier bandwidth (BW) or all carriers in the same frequency band may need to be utilizing the same DL transmission or UL reception directions. For example, FIG. 7 illustrates Conventional TDD carrier or carrier systems. For the 3GPP Rel-18 evolution of the NR system, 3GPP has decided to study the technical feasibilities and potential benefits of subband full duplex (SBFD) systems.
In such a system, a portion of a wide bandwidth carrier may be used for a different direction than that of the rest of the carrier. This is illustrated in the left-hand side of FIG. 8. That is, unlike a conventional TDD system as shown on the left-hand side of FIG. 7 where the entire bandwidth is used for DL transmission in the first three slots, the center portion of the SBFD carrier is used for UL reception while the rest of the carrier continues to be used for DL transmission as shown in the left-hand side of FIG. 8.
Similarly, instead of utilizing all carriers for the same DL or UL directions in a conventional TDD system as shown in the right-hand side of FIG. 7, some carriers in the SBFD system can be used for a different direction than that of the other carriers as shown in the right-hand side of FIG. 8.

In the 3GPP Rel-18 study, the scope has been limited such that in SBFD operation, only network nodes transmit DL and receive UL simultaneously. An individual wireless device is scheduled in only one direction (DL or UL) at a time.

In one existing system for configuration of one or more OFDM symbols of a slot with two or more resource block sets (“RB sets”), each RB set corresponds to a frequency domain subband and has a defined transmission direction (‘D’ or ‘U’). The RB sets may have gaps between them that serve as guardbands where neither DL or UL transmission occurs. In other words, in FIG. 9, there are two example RB set configurations, one with D—U—D configuration and the other with U—D—U configuration. The RB sets are configured either by introduction of new RRC parameter(s) or enhancement of an existing RRC parameter, e.g., TDD-UL-DL-ConfigDedicated. In either case, the parameter(s) signal the size and frequency domain location of the RB sets as well as which symbols/slots in the TDD UL/DL pattern are configured with RB sets.

### Advanced Antenna Arrays for TDD Systems

Modern cellular wireless communication systems utilize advance antenna array systems to perform beamforming and Multiple-input/multiple-output (MIMO) transmission in order to enhance the coverage and throughput of the system. An example antenna array for a TDD system with 32 cross-polarized antenna elements (64 elements in total) is illustrated in FIG. 10. In such an example array, multiple antenna elements are utilized and typically placed in a planar array with horizontal and vertical spacings suitable for the operating frequency bands. For a TDD base station, the antenna array is connected to a TX/RX switch, TX processing chains and RX processing chains such that the same antenna array can be used for transmitting DL signals in a DL slot as well as used for receiving UL signals in an UL slot.

### Antenna Architecture I for SBFD Systems

In an SBFD system, the network node may need to perform DL transmission and UL reception simultaneously. It may be preferred to utilize two antenna arrays for the two directions, respectively as illustrated in FIG. 11, which shows an example antenna architecture I for SBFD systems:
A first antenna array is utilized for UL reception only
A second antenna array is utilized for DL transmission only

It is also may be generally necessary to introduce additional isolation material or mechanisms between the two antenna arrays to suppress the signal leaking from the TX array into the RX array Without such isolation, the UL receiver can be de-sensitized due to the fact that the DL transmit power is generally much higher than the UL receive power.

### Frequency Domain Resource Allocation (FDRA) and Frequency Hopping for PUCCH

In existing Rel-16 specifications, a PUCCH resource of format 1, 3, or 4 (not 0 or 2) can be configured with repetition over 2, 4, or 8 slots. The number of repetitions is indicated by the RRC parameter nrofSlots as shown below. If repetition is configured, then inter-slot frequency hopping can also be configured via the parameter interslotFrequencyHopping as highlighted below. Both parameters are configured on a per-PUCCH format basis, i.e., the repetition and hopping configuration is common to all PUCCH resources of the same format. Note that a PUCCH resource can be configured with hopping within a slot (intra-slot frequency hopping, but not simultaneously with inter-slot frequency hopping.

In Rel-17, dynamic PUCCH repetition was introduced, and the number of repetitions is configured per PUCCH resource (instead of per PUCCH format) by a different parameter, pucch-RepetitionNrofSlots-r17. Unlike Rel-16, this is supported for all PUCCH formats (0,1,2,3,4). Repetition occurs if the PUCCH resource indicator (PRI) field in DCI indicates a PUCCH resource with the parameter pucch-RepetitionNrofSlots-r17 set to either 2, 4, or 8.

```
PUCCH-FormatConfig ::= SEQUENCE {
  interslotFrequencyHopping ENUMERATED {enabled}
OPTIONAL, -- Need R
  additionalDMRS ENUMERATED {true}
OPTIONAL, -- Need R
  maxCodeRate PUCCH-MaxCodeRate
OPTIONAL, -- Need R
  nrofSlots ENUMERATED {n2,n4,n8}
OPTIONAL, -- Need S
  pi2BPSK ENUMERATED {enabled}
OPTIONAL, -- Need R
  simultaneousHARQ-ACK-CSI ENUMERATED {true}
OPTIONAL -- Need R
```

PUCCH-FormatConfig field descriptions:
   With reference to the bolded portions above:
   interslotFrequencyHopping

If the field is present, the wireless device enables inter-slot frequency hopping when PUCCH Format 1, 3 or 4 is repeated over multiple slots. For long PUCCH over multiple slots, the intra and inter slot frequency hopping cannot be enabled at the same time for a wireless device. The field is not applicable for format 2. As further described in 3GPP standards such as, for example, 3GPP TS 38.213, clause 9.2.6.

nrofSlots

Number of slots with the same PUCCH F1, F3 or F4. When the field is absent the wireless device applies the value n1. The field is not applicable for format 2. As further described in 3GPP standards such as, for example, 3GPP TS 38.213, clause 9.2.6.

Frequency hopping is configured per PUCCH resource based on the parameters startingPRB and secondHopPRB (bolded below), which indicate the lowest indexed physical resource block (PRB) within the active bandwidth part (BWP) of the first hop and second hop, respectively, of the PUCCH resource. Hopping alternates between only these two starting PRBs.

| | |
|---|---|
| PUCCH-Resource ::= | SEQUENCE { |
| pucch-ResourceId | PUCCH-ResourceId, |
| startingPRB | PRB-Id, |
| intraSlotFrequencyHopping | ENUMERATED { enabled } |

OPTIONAL, -- Need R

| | |
|---|---|
| secondHopPRB | PRB-Id |
| OPTIONAL, -- Need R | |
| format | CHOICE { |
| format0 | PUCCH-format0, |
| format1 | PUCCH-format1, |
| format2 | PUCCH-format2, |
| format3 | PUCCH-format3, |
| format4 | PUCCH-format4 |
| } | |
| } | |

PUCCH-Resource, PUCCH-ResourceExt field descriptions:

With reference to the bolded portions above:

secondHopPRB

Index of first PRB after frequency hopping of PUCCH. This value is applicable for intra-slot frequency hopping (as described in 3GPP standards such as in, for example, 3GPP TS 38.213, clause 9.2.1) or inter-slot frequency hopping (as described in 3GPP standards such as in, for example, 3GPP TS 38.213, clause 9.2.6).

With PUCCH repetition, the slot in which the first PUCCH transmission of the repetition series occurs is numbered as slot 0, and a slot counter is incremented by 1 for every repetition of the series after that, regardless of whether the PUCCH transmission occurs. It may not occur, for example, if it collides with another PUCCH resource that has higher priority. PUCCH transmissions in slots with even values of the slot counter (0,2,4,6) use startingPRB; and with odd values (1,3,5,7) use secondHopPRB. For unpaired (TDD) spectrum, the wireless device determines the slots used for repetition according to the TDD UL/DL pattern as follows.

### Description of 3GPP TS 38.213, Section 9.2.6

For unpaired spectrum, the wireless device determines the

$${N}_{PUCCH}^{repeat}$$

slots for a PUCCH transmission starting from a slot indicated to the wireless device as described in, for example, clause 9.2.3 for HARQ-ACK reporting, or a slot determined as described in clause 9.2.4 for SR reporting or in clause 5.2.1.4 of 3GPP TS 38.214 for CSI reporting and having:
an UL symbol, as described in clause 11.1, or flexible symbol that is not SS/PBCH block symbol provided by startingSymbolIndex as a first symbol, and
consecutive UL symbols, as described in clause 11.1, or flexible symbols that are not SS/PBCH block symbols, starting from the first symbol, equal to or larger than a number of symbols provided by nrofsymbols.

A PUCCH transmission occurs if the configured symbols of the PUCCH resource overlap with symbols indicated as ‘U’ or as ‘F’ that are not SSB symbols. Typically the repetition slots are not consecutive. An example with eight repetitions is illustrated in FIG. 12. For illustration purposes, the active BWP has a size of 20 PRBs, the PUCCH resource has a size of 2 PRBs, and startingPRB and secondHopPRB have values 0 and 18. In this example, the TDD UL/DL pattern is assumed to be D-D-D-U, and thus PUCCH repetitions occur every 4 slots that align with ‘U’ in the pattern.

However, in the current (3GPP Rel-17) specifications, there is no support for SBFD operation which is characterized by provision of UL resources within symbols that are used simultaneously by the network node for DL transmission. For the case of PUCCH for SBFD with repetition, 3GPP specifications do not support PUCCH transmission over multiple slots in which the number of RBs available for UL transmission is different in different repetitions

In UL-only symbols, the number of available PRBs is equal to the BWP size, denoted

$${N}_{BWP}^{size} .$$

In SBFD symbols, the number of available PRBs is equal to the UL subband size which is less than the BWP size, i.e.,

$${N}_{UL subband}^{size} < {N}_{BWP}^{size} where {N}_{UL subband}^{size}$$

denotes the UL subband size. For example, for a 100 MHz carrier with 30 kHz SCS a BWP spanning the whole carrier has size

$${N}_{BWP}^{size} = 273 .$$

For a typical UL subband roughly 20% of the carrier, and accounting for guardbands, the UL subband size is

$${N}_{UL subband}^{s i z e} = 51 .$$

Hence, existing 3GPP specifications are not without issues.

### SUMMARY

Some embodiments advantageously provide methods, systems, and apparatuses for enable PUCCH transmission with repetition to enable operation across slots in which the number of available UL resources in the frequency domain is different in different slots. For example, in one or more embodiments, the present disclosure enables PUCCH transmission with repetition across both UL-only symbols and SBFD symbols containing a UL frequency subband in which the UL frequency domain resources availability is different in both symbol types.

An advantage of enabling PUCCH with repetition across both SBFD and UL-only slots is that it enables the UL coverage gain for PUCCH promised by SBFD operation in which additional UL transmission opportunities are introduced by allowing the network node to receive UL in simultaneously in slots that it uses for DL transmission.

According to one aspect of the present disclosure, a network node is provided. Network node is configured to transmit to the wireless device control signaling for a physical uplink control channel, PUCCH, transmission. Network node is configured to receive the PUCCH transmission based on the control signaling, the PUCCH transmission spanning a plurality of slots, the plurality of slots including at least one slot containing at least one uplink-only, UL-only, symbol and at least one slot containing at least one subband full duplex, SBFD, symbol, and the PUCCH transmission spans the at least one UL-only symbol and the at least one SBFD symbol.

According to one or more embodiments of this aspect, the control signaling includes a frequency hopping configuration.

According to one or more embodiments of this aspect, the control signaling includes at least one of a higher layer configuration and a downlink control information, DCI, indication.

According to one or more embodiments of this aspect, the wireless device performs at least one of intra-slot frequency hopping and inter-slot frequency hopping in the at least one SBFD symbol based on a UL subband of the at least one SBFD symbol being greater than a threshold.

According to one or more embodiments of this aspect, the wireless device performs at least one of intra-slot frequency hopping and inter-slot frequency hopping in the at least one UL-only symbol but does not perform frequency hopping in the at least one SBFD symbol.

According to one or more embodiments of this aspect, the PUCCH transmission includes a plurality of allocated resource blocks, and the wireless device does not be transmitted PUCCH in the at least one SBFD symbol based on the plurality of allocated resource blocks not being allocated within an UL subband of the at least one SBFD symbol.

According to one or more embodiments of this aspect, the control signaling includes a first indication of a starting resource block for the PUCCH transmission, the starting resource block being within an UL resource block within an UL subband of the at least one SBFD symbol.

According to one or more embodiments of this aspect, the control signaling includes a first indication and a second indication: the first indication corresponding to a first resource block used for transmission of a starting resource block of the PUCCH transmission, the first resource block being within an UL subband of the at least one SBFD symbol; and the second indication indicating a second resource block within the UL subband of the at least one SBFD symbol, the second resource block corresponding to a frequency hop of the PUCCH transmission.

According to one or more embodiments of this aspect, the control signaling includes a first slot repetition counter used for at least one of intra-slot frequency hopping and inter-slot frequency hopping in the at least one SBFD symbol and a second slot repetition counter used for frequency hopping in the at least one UL-only symbol.

According to one or more embodiments of this aspect, the control signaling includes a first resource block offset, and a starting resource block of the PUCCH transmission within an UL subband of the at least one SBFD symbol is based on the first resource block offset.

According to one or more embodiments of this aspect, the control signaling includes a frequency hopping configuration and a second resource block offset, and a starting resource block of a second frequency hop of the PUCCH transmission within an UL subband of the at least one SBFD symbol is based on the second resource block offset

According to one or more embodiments of this aspect, a resource block offset is based on one of: a frequency domain location of a reference resource block in the at least one UL symbol: or a frequency domain location of a reference resource block within an UL subband of the at least one SBFD symbol.

According to one or more embodiments of this aspect, the PUCCH transmission in the at least one UL-only symbol has a first coding rate, and the PUCCH transmission in the at least one SBFD symbol has a second coding rate, the first coding rate being different from the second coding rate.

According to one aspect of the present disclosure, a method performed by a network node is provided. The method includes transmitting, to the wireless device control signaling for a physical uplink control channel, PUCCH, transmission. The method includes receiving the PUCCH transmission based on the control signaling, the PUCCH transmission spanning a plurality of slots, the plurality of slots including at least one slot containing at least one uplink-only, UL-only, symbol and at least one slot containing at least one subband full duplex, SBFD, symbol, and the PUCCH transmission spans the at least one UL-only symbol and the at least one SBFD symbol.

According to one or more embodiments of this aspect, the control signaling includes a frequency hopping configuration.

According to one or more embodiments of this aspect, the control signaling includes at least one of a higher layer configuration and a downlink control information, DCI, indication.

According to one or more embodiments of this aspect, the wireless device performs at least one of intra-slot frequency hopping and inter-slot frequency hopping in the at least one SBFD symbol based on a UL subband of the at least one SBFD symbol being greater than a threshold.

According to one or more embodiments of this aspect, the wireless device performs at least one of intra-slot frequency hopping and inter-slot frequency hopping in the at least one UL-only symbol but does not perform frequency hopping in the at least one SBFD symbol.

According to one or more embodiments of this aspect, the PUCCH transmission includes a plurality of allocated resource blocks, and the wireless device does not be transmitted PUCCH in the at least one SBFD symbol based on the plurality of allocated resource blocks not being allocated within an UL subband of the at least one SBFD symbol.

According to one or more embodiments of this aspect, the control signaling includes a first indication of a starting resource block for the PUCCH transmission, the starting resource block being within an UL resource block within an UL subband of the at least one SBFD symbol.

According to one or more embodiments of this aspect, the control signaling includes a first indication and a second indication: the first indication corresponding to a first resource block used for transmission of a starting resource block of the PUCCH transmission, the first resource block being within an UL subband of the at least one SBFD symbol; and the second indication indicating a second resource block within the UL subband, the second resource block corresponding to a frequency hop of the PUCCH transmission, the second resource block being within the UL subband of the at least one SBFD symbol.

According to one or more embodiments of this aspect, the control signaling includes a first slot repetition counter used for at least one of intra-slot frequency hopping and inter-slot frequency hopping in the at least one SBFD symbol and a second slot repetition counter used for frequency hopping in the at least one UL-only symbol.

According to one or more embodiments of this aspect, the control signaling includes a first resource block offset, and a starting resource block of the PUCCH transmission within an UL subband of the at least one SBFD symbol is based on the first resource block offset.

According to one or more embodiments of this aspect, the control signaling includes a frequency hopping configuration and a second resource block offset, and a starting resource block of a second frequency hop of the PUCCH transmission within an UL subband of the at least one SBFD symbol is based on the second resource block offset

According to one or more embodiments of this aspect, a resource block offset is based on one of: a frequency domain location of a reference resource block in the at least one UL symbol: or a frequency domain location of a reference resource block within an UL subband of the at least one SBFD symbol.

According to one or more embodiments of this aspect, the PUCCH transmission in the at least one UL-only symbol has a first coding rate, and the PUCCH transmission in the at least one SBFD symbol has a second coding rate, the first coding rate being different from the second coding rate.

According to one aspect of the present disclosure, a wireless device is provided. Wireless device is configured to receive control signaling for a physical uplink control channel, PUCCH, transmission. Wireless device is configured to perform the PUCCH transmission based on the control signaling, the PUCCH transmission spanning a plurality of slots, the plurality of slots including at least one slot containing at least one uplink-only, UL-only, symbol and at least one slot containing at least one subband full duplex, SBFD, symbol, and the PUCCH transmission spans the at least one UL-only symbol and the at least one SBFD symbol.

According to one or more embodiments of this aspect, the control signaling includes a frequency hopping configuration.

According to one or more embodiments of this aspect, the control signaling includes at least one of a higher layer configuration and a downlink control information, DCI, indication.

According to one or more embodiments of this aspect, the wireless device performs at least one of intra-slot frequency hopping and inter-slot frequency hopping in the at least one SBFD symbol based on a UL subband of the at least one SBFD symbol being greater than a threshold.

According to one or more embodiments of this aspect, the wireless device performs at least one of intra-slot frequency hopping and inter-slot frequency hopping in the at least one UL-only symbol but does not perform frequency hopping in the at least one SBFD symbol.

According to one or more embodiments of this aspect, the PUCCH transmission includes a plurality of allocated resource blocks, and the wireless device does not be transmitted PUCCH in the at least one SBFD symbol based on the plurality of allocated resource blocks not being allocated within an UL subband of the at least one SBFD symbol.

According to one or more embodiments of this aspect, the control signaling includes a first indication of a starting resource block for the PUCCH transmission, the starting resource block being within an UL resource block within an UL subband of the at least one SBFD symbol.

According to one or more embodiments of this aspect, the control signaling includes a first indication and a second indication: the first indication corresponding to a first resource block used for transmission of a starting resource block of the PUCCH transmission, the first resource block being within an UL subband of the at least one SBFD symbol; and the second indication indicating a second resource block within the UL subband of the at least one SBFD symbol, the second resource block corresponding to a frequency hop of the PUCCH transmission.

According to one or more embodiments of this aspect, the control signaling includes a first slot repetition counter used for at least one of intra-slot frequency hopping and inter-slot frequency hopping in the at least one SBFD symbol and a second slot repetition counter used for frequency hopping in the at least one UL-only symbol.

According to one or more embodiments of this aspect, the control signaling includes a first resource block offset, and a starting resource block of the PUCCH transmission within an UL subband of the at least one SBFD symbol is based on the first resource block offset.

According to one or more embodiments of this aspect, the control signaling includes a frequency hopping configuration and a second resource block offset, and a starting resource block of a second frequency hop of the PUCCH transmission within an UL subband of the at least one SBFD symbol is based on the second resource block offset

According to one or more embodiments of this aspect, a resource block offset is based on one of: a frequency domain location of a reference resource block in the at least one UL symbol: or a frequency domain location of a reference resource block within an UL subband of the at least one SBFD symbol.

According to one or more embodiments of this aspect, the PUCCH transmission in the at least one UL-only symbol has a first coding rate, and the PUCCH transmission in the at least one SBFD symbol has a second coding rate, the first coding rate being different from the second coding rate.

According to one aspect of the present disclosure, a method performed by a wireless device is provided. The method includes receiving control signaling for a physical uplink control channel, PUCCH, transmission. The method includes performing the PUCCH transmission based on the control signaling, the PUCCH transmission spanning a plurality of slots, the plurality of slots including at least one slot containing at least one uplink-only, UL-only, symbol and at least one slot containing at least one subband full duplex, SBFD, symbol, and the PUCCH transmission spans the at least one UL-only symbol and the at least one SBFD symbol.

According to one or more embodiments of this aspect, the control signaling includes a frequency hopping configuration.

According to one or more embodiments of this aspect, the control signaling includes at least one of a higher layer configuration and a downlink control information, DCI, indication.

According to one or more embodiments of this aspect, the wireless device performs at least one of intra-slot frequency hopping and inter-slot frequency hopping in the at least one SBFD symbol based on a UL subband of the at least one SBFD symbol being greater than a threshold.

According to one or more embodiments of this aspect, the wireless device performs at least one of intra-slot frequency hopping and inter-slot frequency hopping in the at least one UL-only symbol but does not perform frequency hopping in the at least one SBFD symbol.

According to one or more embodiments of this aspect, the PUCCH transmission includes a plurality of allocated resource blocks, and the wireless device does not be transmitted PUCCH in the at least one SBFD symbol based on the plurality of allocated resource blocks not being allocated within an UL subband of the at least one SBFD symbol.

According to one or more embodiments of this aspect, the control signaling includes a first indication of a starting resource block for the PUCCH transmission, the starting resource block being within an UL resource block within an UL subband of the at least one SBFD symbol.

According to one or more embodiments of this aspect, the control signaling includes a first indication and a second indication; the first indication corresponding to a first resource block used for transmission of a starting resource block of the PUCCH transmission, the first resource block being within an UL subband of the at least one SBFD symbol; and the second indication indicating a second resource block within the UL subband of the at least one SBFD symbol, the second resource block corresponding to a frequency hop of the PUCCH transmission.

According to one or more embodiments of this aspect, the control signaling includes a first slot repetition counter used for at least one of intra-slot frequency hopping and inter-slot frequency hopping in the at least one SBFD symbol and a second slot repetition counter used for frequency hopping in the at least one UL-only symbol.

According to one or more embodiments of this aspect, the control signaling includes a first resource block offset, and a starting resource block of the PUCCH transmission within an UL subband of the at least one SBFD symbol is based on the first resource block offset.

According to one or more embodiments of this aspect, the control signaling includes a frequency hopping configuration and a second resource block offset, and a starting resource block of a second frequency hop of the PUCCH transmission within an UL subband of the at least one SBFD symbol is based on the second resource block offset

According to one or more embodiments of this aspect, a resource block offset is based on one of: a frequency domain location of a reference resource block in the at least one UL symbol: or a frequency domain location of a reference resource block within an UL subband of the at least one SBFD symbol.

According to one or more embodiments of this aspect, the PUCCH transmission in the at least one UL-only symbol has a first coding rate, and the PUCCH transmission in the at least one SBFD symbol has a second coding rate, the first coding rate being different from the second coding rate.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a diagram of an example radio resource:

FIG. 2 is a diagram of an example of a slot:

FIG. 3 is a diagram of an example of frequency- and time-division duplex:

FIG. 4 is a diagram of Uplink/downlink time/frequency structure in case of FDD or TDD

FIG. 5 is a diagram of an example TDD DL/UL pattern:

FIG. 6 is a diagram of example TDD DL/UL patterns:

FIG. 7 is a diagram of an example of Conventional TDD carrier or carrier systems:

FIG. 8 is a diagram of subband full duplex systems:

FIG. 9 is a diagram of example RB set configurations:

FIG. 10 is a diagram of an example of a TDD antenna array:

FIG. 11 is a diagram of an example Antenna architecture:

FIG. 12 is a diagram of an example of PUCCH repetition:

FIG. 13 is a schematic diagram of an example network architecture illustrating a communication system connected via an intermediate network to a host computer according to the principles in the present disclosure;

FIG. 14 is a block diagram of a host computer communicating via a network node with a wireless device over an at least partially wireless connection according to some embodiments of the present disclosure:

FIG. 15 is a flowchart illustrating example methods implemented in a communication system including a host computer, a network node and a wireless device for executing a client application at a wireless device according to some embodiments of the present disclosure;

FIG. 16 is a flowchart illustrating example methods implemented in a communication system including a host computer, a network node and a wireless device for receiving user data at a wireless device according to some embodiments of the present disclosure:

FIG. 17 is a flowchart illustrating example methods implemented in a communication system including a host computer, a network node and a wireless device for receiving user data from the wireless device at a host computer according to some embodiments of the present disclosure:

FIG. 18 is a flowchart illustrating example methods implemented in a communication system including a host computer, a network node and a wireless device for receiving user data at a host computer according to some embodiments of the present disclosure:

FIG. 19 is a flowchart of an example process in a network node for enabling PUCCH transmission according to some embodiments of the present disclosure:

FIG. 20 is a flowchart of an example process in a wireless device for enabling PUCCH transmission according to some embodiments of the present disclosure:

FIG. 21 is a flowchart of another example process in a network node according to some embodiments of the present disclosure:

FIG. 22 is a flowchart of another example process in a wireless device according to some embodiments of the present disclosure:

FIG. 23 is a diagram of an example of UL transmission according to some embodiments of the present disclosure:

FIG. 24 is a diagram of an example embodiment:

FIG. 25 is a diagram of an example relating to frequency hopping:

FIG. 26 is a diagram of an example embodiment; and

FIG. 27 is a diagram of an example embodiment.

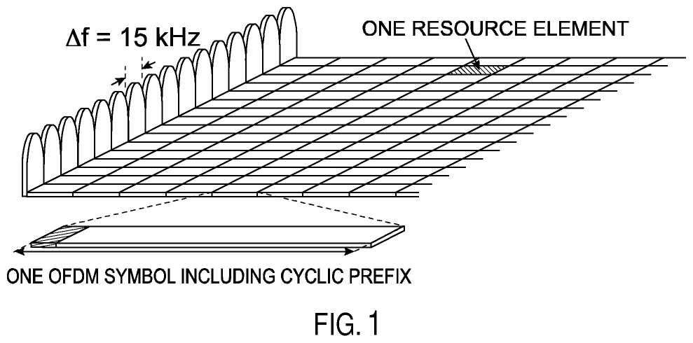

### DETAILED DESCRIPTION

Before describing in detail example embodiments, it is noted that the embodiments reside primarily in combinations of apparatus components and processing steps related to enabling operation across slots in which the number of available UL resources in the frequency domain is different in different slots. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising.” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IOT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

In some embodiments, the general description elements in the form of “one of A and B” corresponds to A or B. In some embodiments, at least one of A and B corresponds to A, B or AB, or to one or more of A and B. In some embodiments, at least one of A, B and C corresponds to one or more of A, B and C, and/or A, B, C or a combination thereof.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide for enabling PUCCH transmission, including with repetition across both UL-only symbols and SBFD symbols containing a UL frequency subband in which the UL frequency domain resources availability is different in both symbol types.

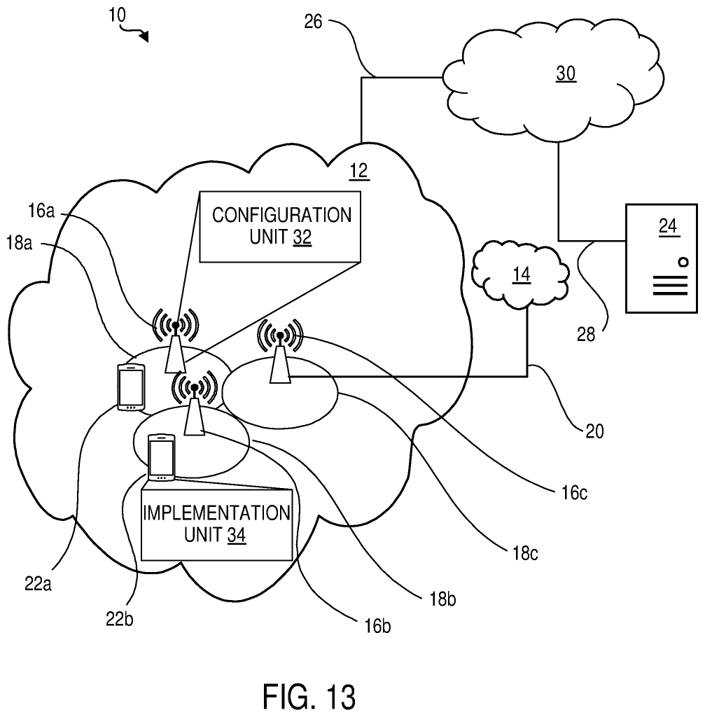

Referring again to the drawing figures, in which like elements are referred to by like reference numerals, there is shown in FIG. 13 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 13 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a configuration unit 32 which is configured to perform one or more network node 16 functions described herein such as, for example, including functions related to enabling PUCCH transmission. A wireless device 22 is configured to include an implementation unit 34 which is configured to perform one or more network node 16 functions described herein such as, for example, including functions related to enabling PUCCH transmission.

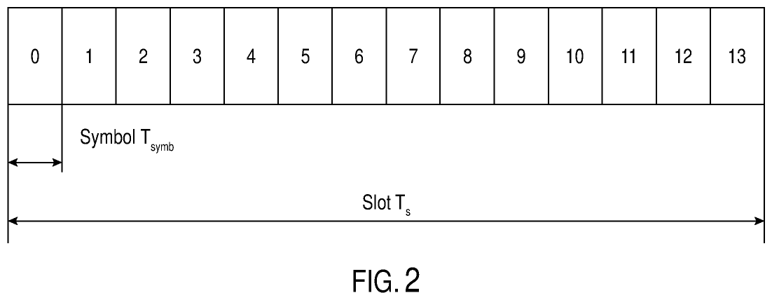

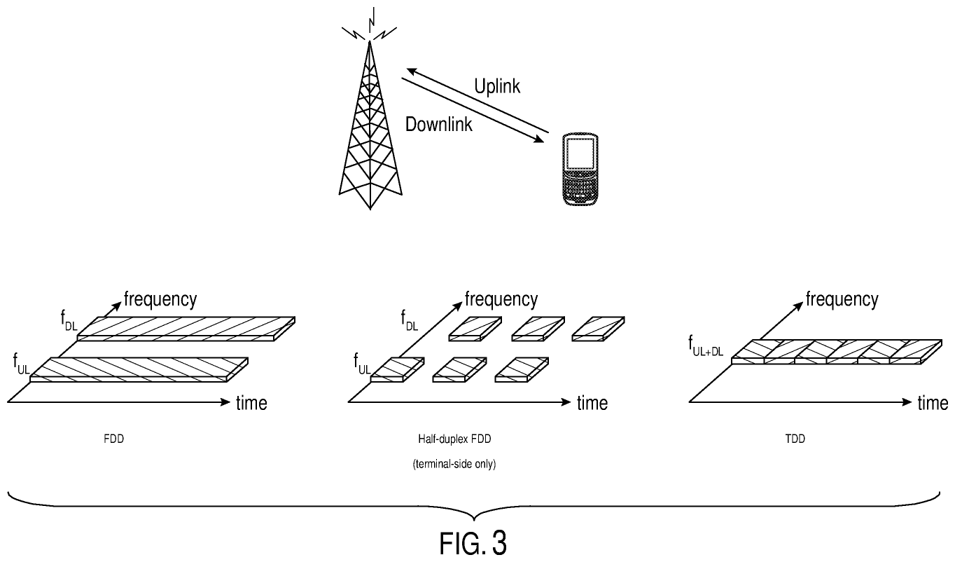

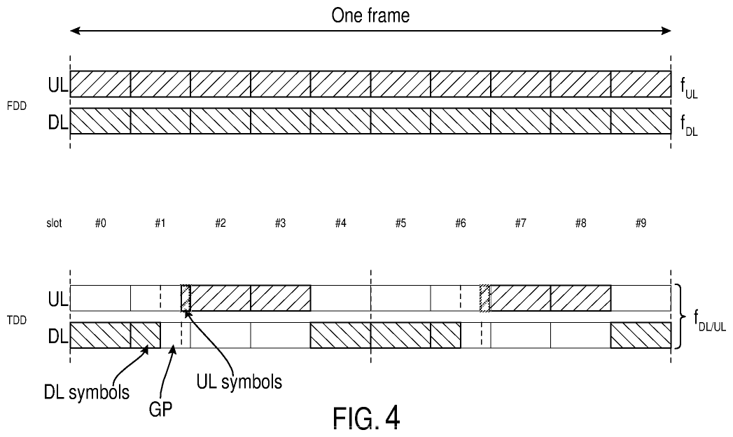

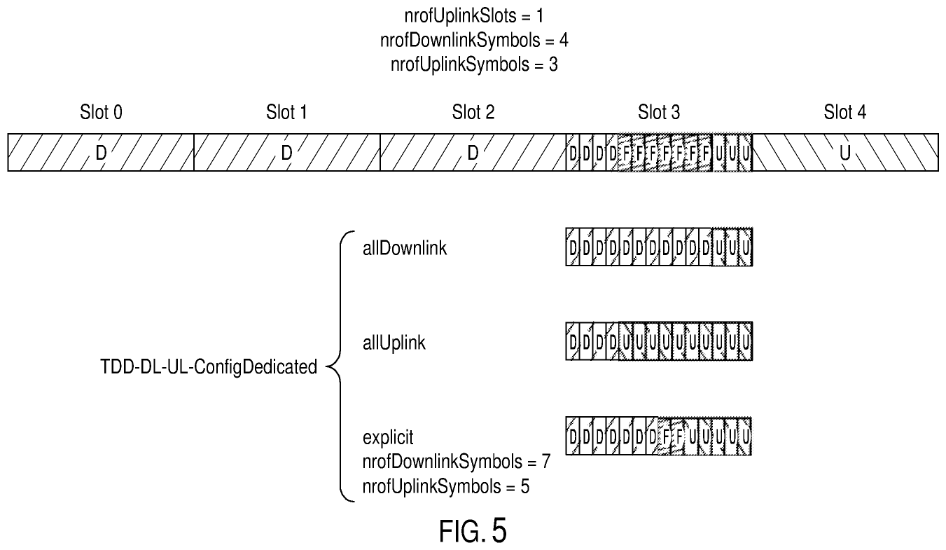

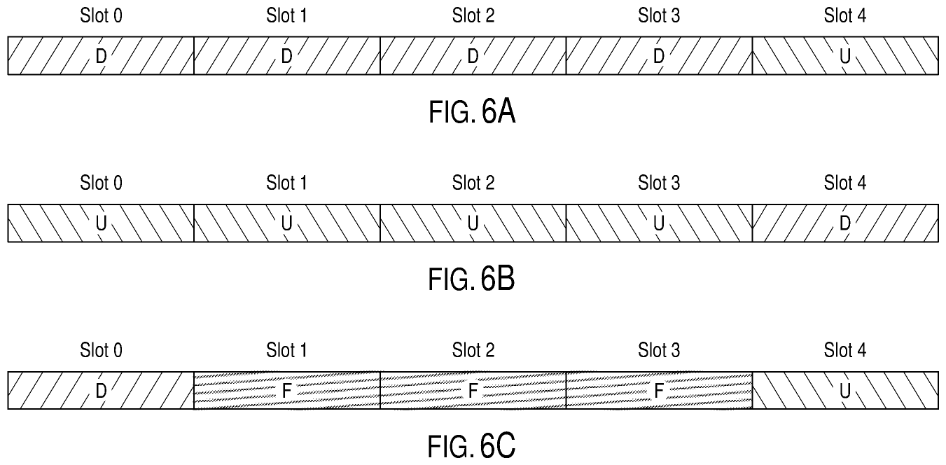

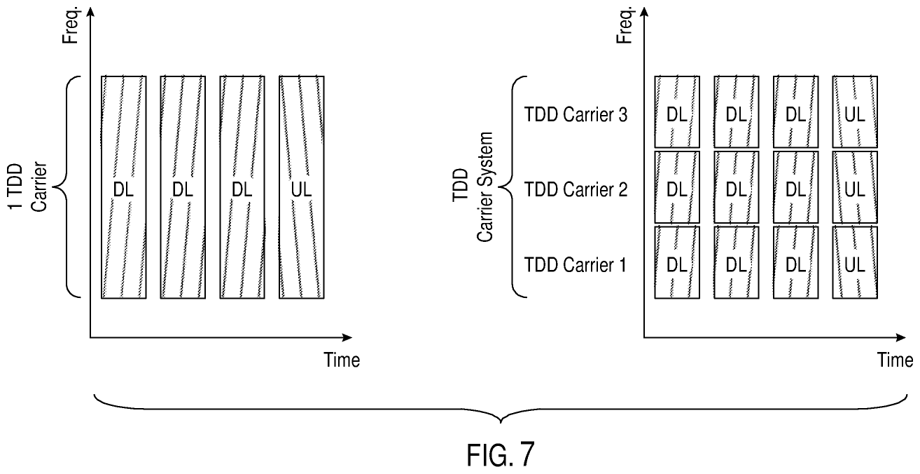

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include a control unit 54 configured to enable the service provider to observe/monitor/control/transmit to/receive from the network node 16 and/or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include configuration unit 32 configured to configured to perform one or more network node 16 functions described herein such as, for example, including functions related to enabling PUCCH transmission.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a implementation unit 34 configured to configured to perform one or more network node 16 functions described herein such as, for example, including functions related to enabling PUCCH transmission.

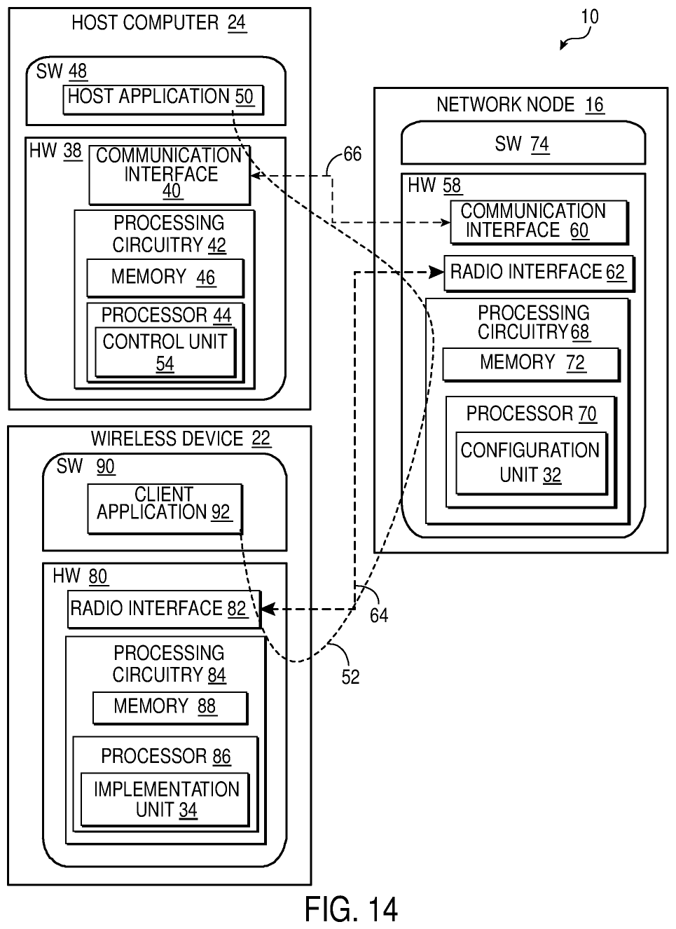

In some embodiments, the inner workings of the network node 16, WD 22, and host computer 24 may be as shown in FIG. 14 and independently, the surrounding network topology may be that of FIG. 13.

In FIG. 14, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes: the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.: the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 13 and 14 show various “units” such as configuration unit 32, and implementation unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

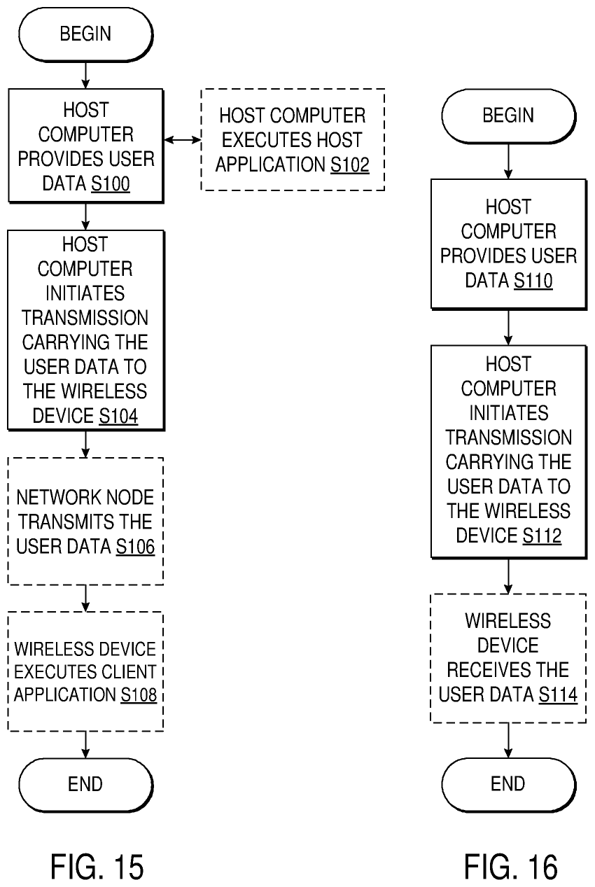

FIG. 15 is a flowchart illustrating an example method implemented in a communication system, such as, for example, the communication system of FIGS. 13 and 14, in accordance with one embodiment. The communication system may include a host computer 24, a network node 16 and a WD 22, which may be those described with reference to FIG. 14. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 16 is a flowchart illustrating an example method implemented in a communication system, such as, for example, the communication system of FIG. 13, in accordance with one embodiment. The communication system may include a host computer 24, a network node 16 and a WD 22, which may be those described with reference to FIGS. 13 and 14. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

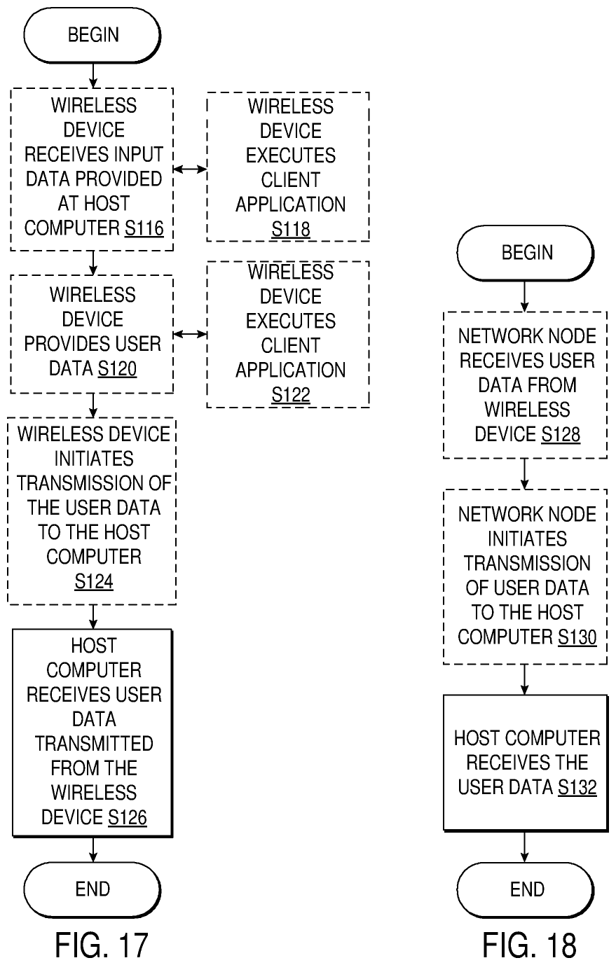

FIG. 17 is a flowchart illustrating an example method implemented in a communication system, such as, for example, the communication system of FIG. 13, in accordance with one embodiment. The communication system may include a host computer 24, a network node 16 and a WD 22, which may be those described with reference to FIGS. 13 and 14. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 18 is a flowchart illustrating an example method implemented in a communication system, such as, for example, the communication system of FIG. 13, in accordance with one embodiment. The communication system may include a host computer 24, a network node 16 and a WD 22, which may be those described with reference to FIGS. 13 and 14. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

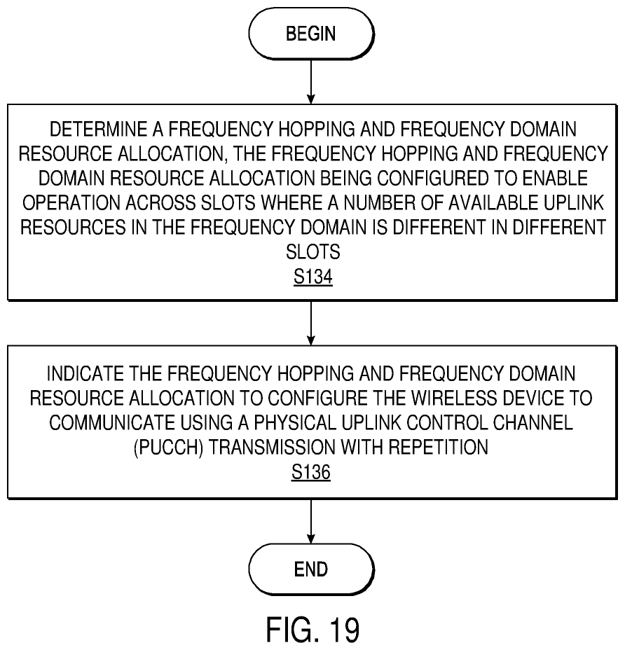

FIG. 19 is a flowchart of an example process in a network node 16 according to some embodiments of the present disclosure. One or more blocks described herein may be performed by one or more elements of network node 16 such as by one or more of processing circuitry 68 (including the configuration unit 32), processor 70, radio interface 62 and/or communication interface 60. Network node 16 is configured to determine a frequency hopping and frequency domain resource allocation where the frequency hopping and frequency domain resource allocation is configured to enable operation across slots where a number of available uplink resources in the frequency domain is different in different slots (Block S134). The network node 16 is configured to indicate the frequency hopping and frequency domain resource allocation to configure the wireless device to communicate using a PUCCH transmission with repetition (Block S136).

In at least one embodiment, the wireless device is configured not to use frequency hopping for a PUCCH transmission in UL-only symbols. In at least one embodiment, the wireless device is configured to not employ frequency hopping if the upload subband size is less than a predetermined threshold.

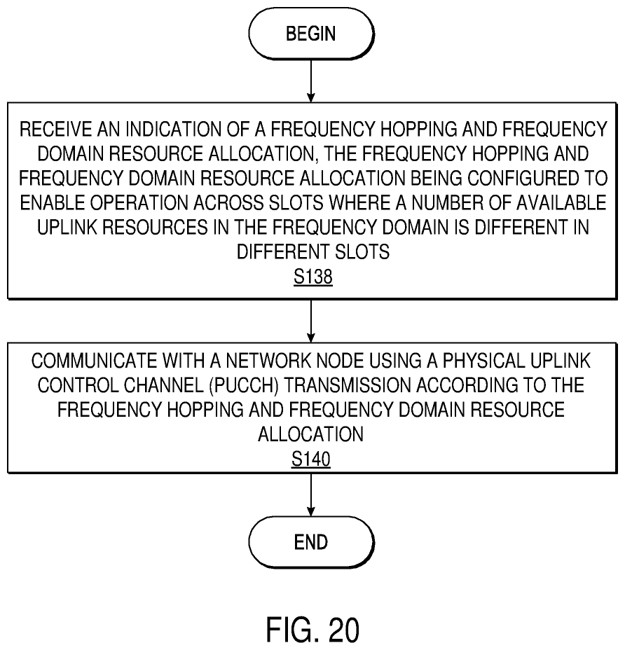

FIG. 20 is a flowchart of an example process in a wireless device 22 according to some embodiments of the present disclosure. One or more blocks described herein may be performed by one or more elements of wireless device 22 such as by one or more of processing circuitry 84 (including the implementation unit 34), processor 86, radio interface 82 and/or communication interface 60. Wireless device 22 is configured to receive an indication of a frequency hopping and frequency domain resource allocation where the frequency hopping and frequency domain resource allocation is configured to enable operation across slots where a number of available uplink resources in the frequency domain is different in different slots (Block S138). The wireless device 22 is configured to communicate with a network node using a PUCCH transmission according to the frequency hopping and frequency domain resource allocation (Block S140).

In at least one embodiment, the wireless device is configured not to use frequency hopping for a PUCCH transmission in UL-only symbols. In at least one embodiment, the wireless device is configured to not employ frequency hopping if the upload subband size is less than a predetermined threshold.

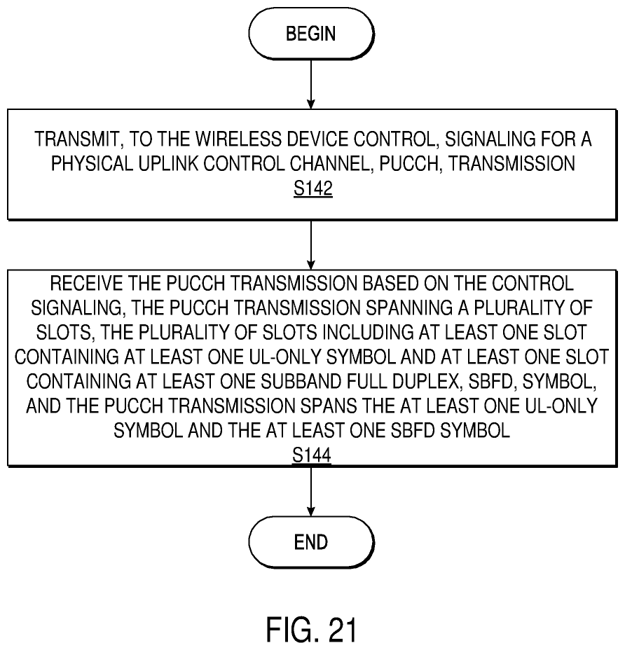

FIG. 21 is a flowchart of another example process in a network node 16 according to some embodiments of the present disclosure. One or more blocks described herein may be performed by one or more elements of network node 16 such as by one or more of processing circuitry 68 (including the configuration unit 32), processor 70, radio interface 62 and/or communication interface 60. Network node 16 is configured to transmit (Block S142), to the wireless device (22), control signaling for a physical uplink control channel, PUCCH, transmission. Network node 16 is configured to receive (Block S144) the PUCCH transmission based on the control signaling, the PUCCH transmission spanning a plurality of slots, the plurality of slots including at least one slot containing at least one uplink-only, UL-only, symbol and at least one slot containing at least one subband full duplex, SBFD, symbol, and the PUCCH transmission spans the at least one UL-only symbol and the at least one SBFD symbol.

In at least one embodiment, the control signaling includes a frequency hopping configuration.

In at least one embodiment, the control signaling includes at least one of a higher layer configuration and a downlink control information, DCI, indication.

In at least one embodiment, the wireless device 22 performs at least one of intra-slot frequency hopping and inter-slot frequency hopping in the at least one SBFD symbol based on a UL subband of the at least one SBFD symbol being greater than a threshold.

In at least one embodiment, the wireless device 22 performs at least one of intra-slot frequency hopping and inter-slot frequency hopping in the at least one UL-only symbol but does not perform frequency hopping in the at least one SBFD symbol.

In at least one embodiment, the PUCCH transmission includes a plurality of allocated resource blocks, and the wireless device 22 does not be transmitted PUCCH in the at least one SBFD symbol based on the plurality of allocated resource blocks not being allocated within an UL subband of the at least one SBFD symbol.

In at least one embodiment, the control signaling includes a first indication of a starting resource block for the PUCCH transmission, the starting resource block being within an UL resource block within an UL subband of the at least one SBFD symbol.

In at least one embodiment, the control signaling includes a first indication and a second indication; the first indication corresponding to a first resource block used for transmission of a starting resource block of the PUCCH transmission, the first resource block being within an UL subband of the at least one SBFD symbol; and the second indication indicating a second resource block within the UL subband of the at least one SBFD symbol, the second resource block corresponding to a frequency hop of the PUCCH transmission.

In at least one embodiment, the control signaling includes a first slot repetition counter used for at least one of intra-slot frequency hopping and inter-slot frequency hopping in the at least one SBFD symbol and a second slot repetition counter used for frequency hopping in the at least one UL-only symbol.

In at least one embodiment, the control signaling includes a first resource block offset, and a starting resource block of the PUCCH transmission within an UL subband of the at least one SBFD symbol is based on the first resource block offset.

In at least one embodiment, the control signaling includes a frequency hopping configuration and a second resource block offset, and a starting resource block of a second frequency hop of the PUCCH transmission within an UL subband of the at least one SBFD symbol is based on the second resource block offset

In at least one embodiment, a resource block offset is based on one of: a frequency domain location of a reference resource block in the at least one UL symbol: or a frequency domain location of a reference resource block within an UL subband of the at least one SBFD symbol.

In at least one embodiment, the PUCCH transmission in the at least one UL-only symbol has a first coding rate, and the PUCCH transmission in the at least one SBFD symbol has a second coding rate, the first coding rate being different from the second coding rate.

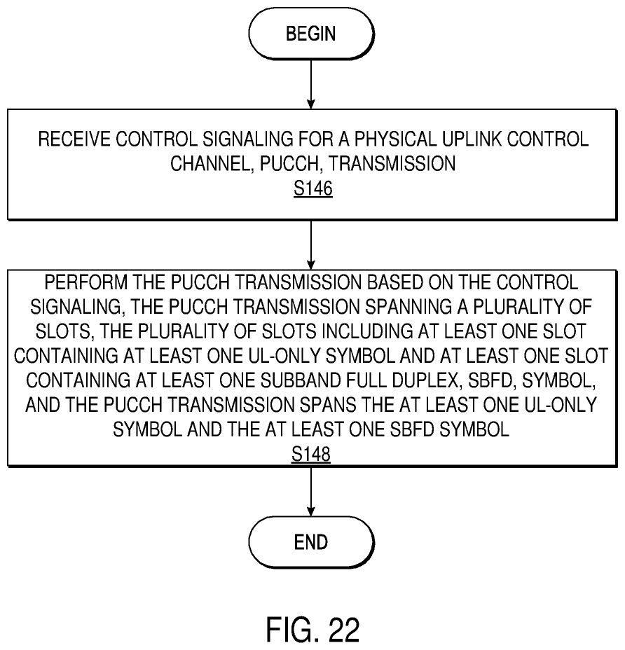

FIG. 22 is a flowchart of an exemplary process in a wireless device 22 according to some embodiments of the present disclosure. One or more blocks described herein may be performed by one or more elements of wireless device 22 such as by one or more of processing circuitry 84 (including the implementation unit 34), processor 86, radio interface 82 and/or communication interface 60. Wireless device 22 is configured to receive (Block S146) control signaling for a physical uplink control channel, PUCCH, transmission. Wireless device 22 is configured to perform (Block S148) the PUCCH transmission based on the control signaling, the PUCCH transmission spanning a plurality of slots, the plurality of slots including at least one slot containing at least one uplink-only, UL-only, symbol and at least one slot containing at least one subband full duplex, SBFD, symbol, and the PUCCH transmission spans the at least one UL-only symbol and the at least one SBFD symbol.

In at least one embodiment, the control signaling includes a frequency hopping configuration.

In at least one embodiment, the control signaling includes at least one of a higher layer configuration and a downlink control information, DCI, indication.

In at least one embodiment, the wireless device 22 performs at least one of intra-slot frequency hopping and inter-slot frequency hopping in the at least one SBFD symbol based on a UL subband of the at least one SBFD symbol being greater than a threshold.

In at least one embodiment, the wireless device 22 performs at least one of intra-slot frequency hopping and inter-slot frequency hopping in the at least one UL-only symbol but does not perform frequency hopping in the at least one SBFD symbol.

In at least one embodiment, the PUCCH transmission includes a plurality of allocated resource blocks, and the wireless device 22 does not be transmitted PUCCH in the at least one SBFD symbol based on the plurality of allocated resource blocks not being allocated within an UL subband of the at least one SBFD symbol.

In at least one embodiment, the control signaling includes a first indication of a starting resource block for the PUCCH transmission, the starting resource block being within an UL resource block within an UL subband of the at least one SBFD symbol.

In at least one embodiment, the control signaling includes a first indication and a second indication: the first indication corresponding to a first resource block used for transmission of a starting resource block of the PUCCH transmission, the first resource block being within an UL subband of the at least one SBFD symbol; and the second indication indicating a second resource block within the UL subband of the at least one SBFD symbol, the second resource block corresponding to a frequency hop of the PUCCH transmission.

In at least one embodiment, the control signaling includes a first slot repetition counter used for at least one of intra-slot frequency hopping and inter-slot frequency hopping in the at least one SBFD symbol and a second slot repetition counter used for frequency hopping in the at least one UL-only symbol.

In at least one embodiment, the control signaling includes a first resource block offset, and a starting resource block of the PUCCH transmission within an UL subband of the at least one SBFD symbol is based on the first resource block offset.

In at least one embodiment, the control signaling includes a frequency hopping configuration and a second resource block offset, and a starting resource block of a second frequency hop of the PUCCH transmission within an UL subband of the at least one SBFD symbol is based on the second resource block offset

In at least one embodiment, a resource block offset is based on one of: a frequency domain location of a reference resource block in the at least one UL symbol: or a frequency domain location of a reference resource block within an UL subband of the at least one SBFD symbol.

In at least one embodiment, the PUCCH transmission in the at least one UL-only symbol has a first coding rate, and the PUCCH transmission in the at least one SBFD symbol has a second coding rate, the first coding rate being different from the second coding rate.

Having described the general process flow of arrangements of the disclosure and having provided examples of hardware and software arrangements for implementing the processes and functions of the disclosure, the sections below provide details and examples of arrangements for enabling PUCCH transmission.

One or more wireless device 22 functions described below may be performed by one or more of processing circuitry 84, processor 86, implementation unit 34, etc. One or more network node 16 functions described below may be performed by one or more of processing circuitry 68, processor 70, configuration unit 32, etc.

Some embodiments provide for enabling PUCCH transmission with repetition across both UL-only symbols and SBFD symbols containing a UL frequency subband in which the UL frequency domain resources availability is different in both symbol types.

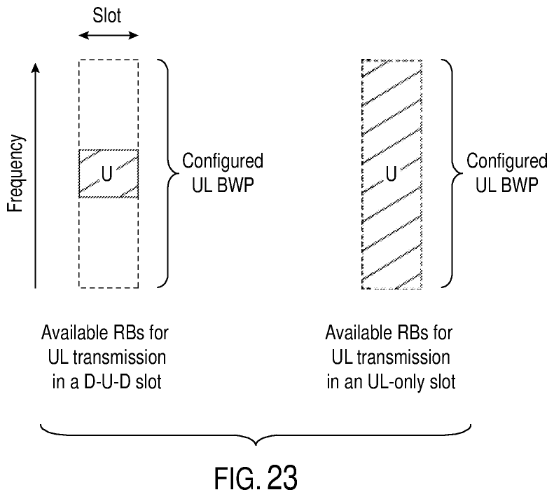

FIG. 23 depicts an example of available RBs for UL transmission within the UL BWP for SBFD symbols and UL-only symbols.

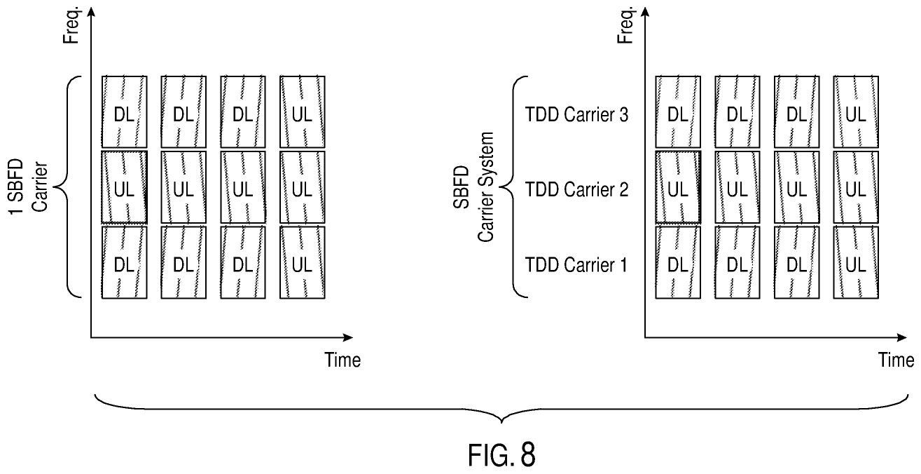

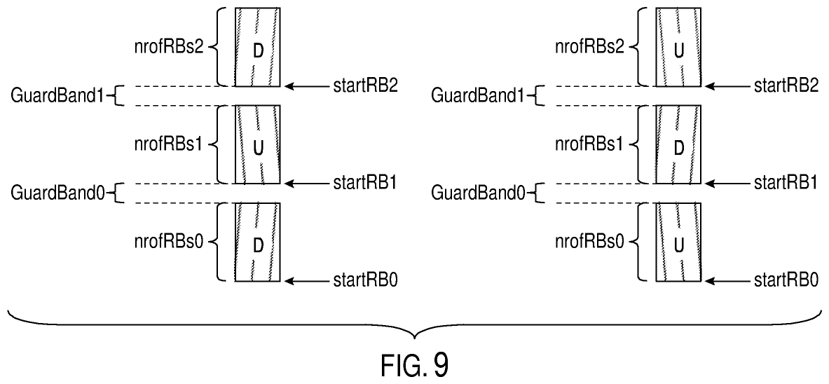

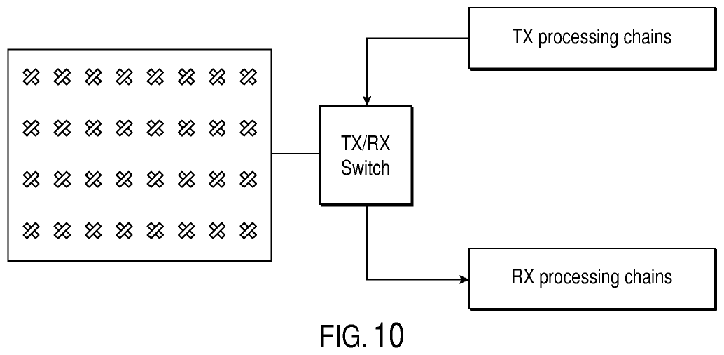

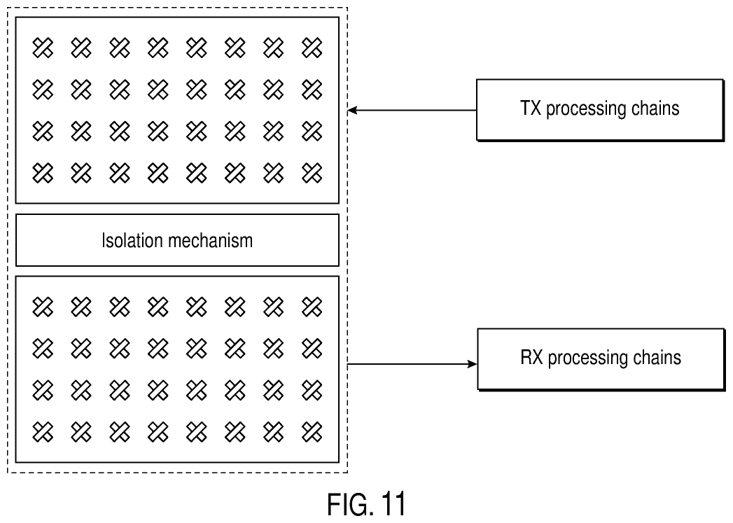

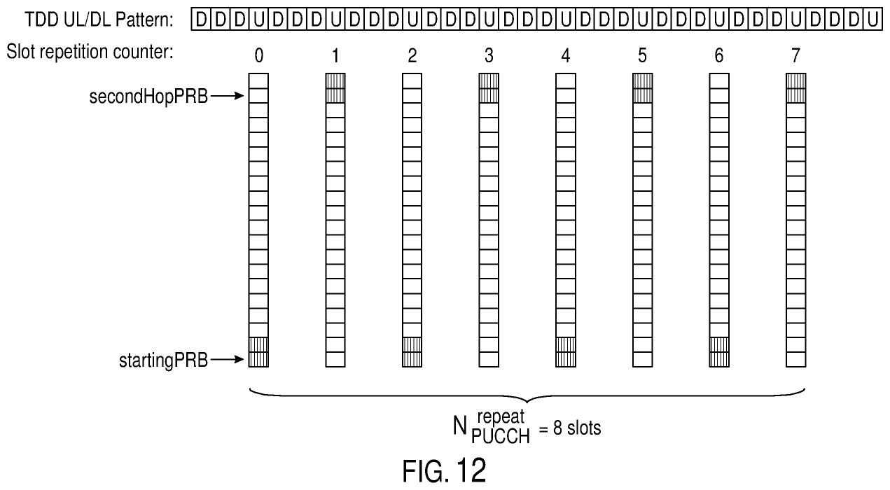

In at least one of the following embodiments, an SBFD symbol is a symbol that is configured such that it can be used for SBFD operation, i.e., simultaneous network node 16 transmission/reception within the same carrier. For example, an SBFD symbol contains two ‘D’ frequency subbands (RB sets) and one ‘U’ subband (RB set) in the middle of the carrier-a so-called D-U-D configuration. In contrast an UL-only symbol is a symbol in which can only be used for wireless device 22 transmission within the carrier. The two symbol types are illustrated in FIG. 8 where the number of RBs available for PUCCH is different in the SBFD symbols compared to the UL-only symbols.

In various embodiments, such as those set forth below, it is generally understood that a PUCCH can be within a single slot or can occupy multiple slots, i.e., PUCCH with repetition. In SBFD operation, PUCCH with repetition can thus span different symbol types, i.e., one repetition in a slot with UL-only symbols, and another repetition in a slot with SBFD symbols.

In some embodiments, when a reference is made to “the FDRA parameters according to the current NR/3GPP specification and protocols for a PUCCH transmission,” it may refers to the RRC parameters:
startingPRB that provides the starting PRB index for the PUCCH frequency domain resource allocation for a PUCCH transmission (repetition)
secondHopPRB that provides the starting PRB index for the PUCCH frequency domain resource allocation (FDRA) for the second hop of a PUCCH transmission (repetition), if inter-slot frequency hopping is configured

In some embodiments, a non-limiting exemplary system configuration is used for illustration:
The UL BWP size

$${N}_{BWP}^{s i z e} = 273 RBs$$

The UL subband size

$${N}_{ULsubband}^{s i z e} = 51 RBs$$

The first UL subband RB index within the BWP is

$$R {B}_{start}^{ULsubband} = 111$$

The last UL subband RB index within the BWP is

$${RB}_{end}^{ULsubband} = {RB}_{start}^{ULsubband} + {N}_{ULsubband}^{size} - 1 = 161$$

### Embodiment Group a (Frequency Hopping Determination)

### Embodiment #A-1

In at least one embodiment, if frequency hopping is configured for a PUCCH resource, the starting PRB index for the 2nd hop is first determined according to the existing RRC parameter secondHopPRB according to the existing NR/3GPP specifications and protocols for a PUCCH transmission in UL-only symbols. For a PUCCH transmission in SBFD symbols, the wireless device 22 does not employ frequency hopping. That is, the wireless device 22 ignores the secondHopPRB for a PUCCH transmission in a mixed direction slot. This is because typically

$${N}_{UL subband}^{size}$$

is much less than

$${N}_{BWP}^{size}$$

and the potential frequency diversity in the UL subband is much less than in the full BWP during UL-only symbols.

### Embodiment #A-2

In at least one embodiment, if frequency hopping is configured for a PUCCH resource, the starting PRB index for the 2nd hop is first determined according to the existing RRC parameter secondHopPRB according to the existing NR/3GPP specifications and protocols for a PUCCH transmission in UL-only symbols. For a PUCCH transmission in SBFD symbols:
the wireless device 22 does not employ frequency hopping if the UL subband size is smaller than a threshold
the wireless device 22 performs PUCCH frequency hopping based on the RRC parameter secondHopPRB according to the current NR specs and protocols.

### Embodiment Group B (Based on Overlapping FDRA)

In some embodiments, the PUCCH FDRA parameters (startingPRB, secondHopPRB) are interpreted according to existing NR/3GPP specifications for a PUCCH transmission in UL-only symbols.

### Embodiment #B-1

At least one embodiment inherits the frequency hopping determination procedure in either Embodiment #A-1 or #A-2 for SBFD symbols if frequency hopping is configured.

Additionally, the wireless device 22 performs a PUCCH transmission in SBFD symbols if the allocated RBs (1st or 2nd hop) fall within the UL subband:

For instance, a PUCCH allocated for RB #121 to RB #124 is transmitted in SBFD symbols since the RBs are part of the UL subband.

However, a PUSCH allocated for RB #10 to RB #13 may not be transmitted in SBFD symbols since these RBs are not part of the UL subband.

### Embodiment Group C (Based on Slot-Dependent FDRA Interpretation)

In some embodiments, the PUCCH FDRA parameters (startingPRB, secondHopPRB) may be interpreted according to existing NR/3GPP specifications for a PUCCH transmission in UL-only symbols.

### Embodiment #C-1 (RRC Parameters for SBFD Symbols)

In at least one embodiment, for a PUCCH transmission in SBFD symbols:
A first new RRC parameter is defined to indicate the RB start index for PUCCH, e.g., startingPRB2, where the RB index is contained within the ‘U’ subband in SBFD symbols
A second new RRC parameter is defined to indicate the RB start index for the 2nd hop of a PUCCH transmission if frequency hopping is configured, e.g., secondHopPRB2, where the RB index is contained within the ‘U’ subband in SBFD symbols

In a variation of this embodiment, frequency hopping is applied based on either one of the Group A embodiments.

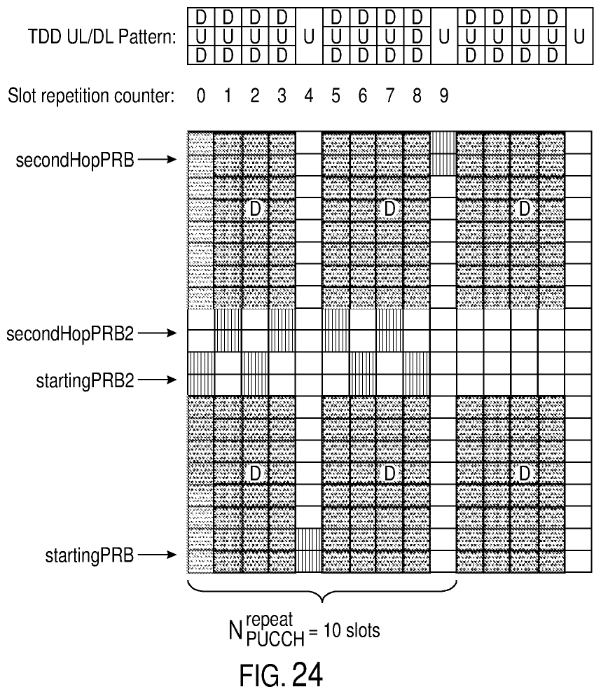

FIG. 24 shows an example of this embodiment for a TDD pattern in which the first 4 slots contain an UL subband and the 5th slot is UL-only. The PUCCH may be configured with ten repetitions (2 cycles of the TDD pattern) and with frequency hopping. For UL-only slots 4 and 9, the starting RB and number of RBs for the 1st and 2nd hops and the RB offset for the 2nd hop are determined according to the current NR specs and protocols. For the SBFD slots 0, 1, 2, 3, 5, 6, 7, 8, the starting RB for the 1st and 2nd hops are determined according to the new parameters disclosed in this embodiment, such that they are within the UL subband.

### Embodiment #C-2 (Different Slot Repetition Counters)

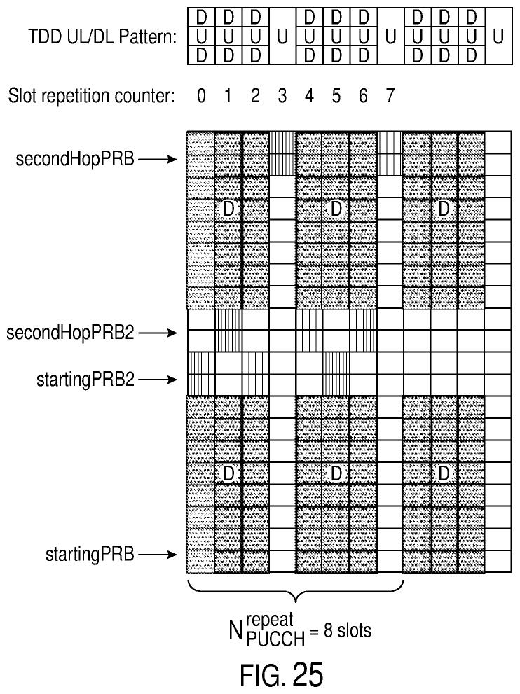

In the case of an embodiment in accordance with #C-1, depending on the length of the TDD UL/DL pattern and the number of UL-only slots, the UL-only slots may correspond to only odd values or only even value of the slot repetition counter. In this case, the PUCCH PRB allocation in the UL-only slots may not vary (hop) with time. In other words, the frequency hopping gain in UL-only symbols may not be realized. This is illustrated in the example of FIG. 25.

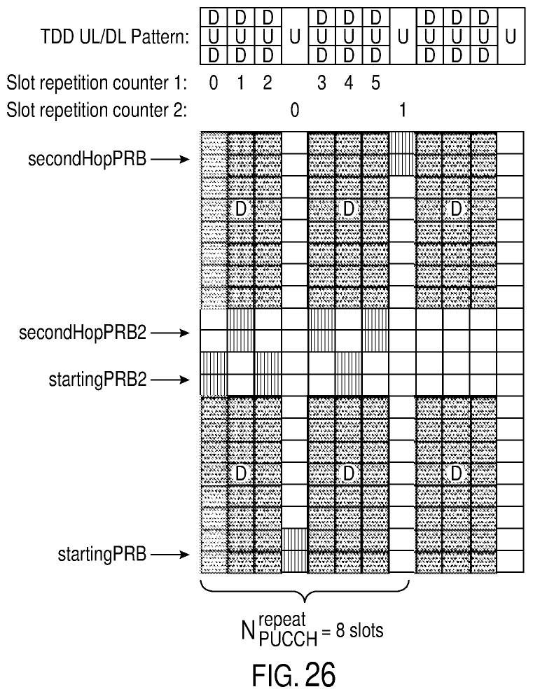

At least one embodiment includes one or more aspects of an embodiment in accordance with #C-1, but with one or more modification now described. To remove the dependency of the frequency hopping gain on the TDD pattern, some embodiments introduce a second slot repetition counter. The first slot repetition counter is used for SBFD slots and increments by one for each slot. The second repetition counter is used for UL-only symbols and increments by one for each UL-only slot. In this way, frequency hopping within the same symbol type may always occur, regardless of the specific TDD pattern. This is illustrated in the example of FIG. 26. Comparing FIG. 26 to FIG. 25, it is shown that full frequency hopping may occur in both SBFD slots and UL-only slots.

### Embodiment #C-3 (Starting RB Indices Based on RB Offsets)

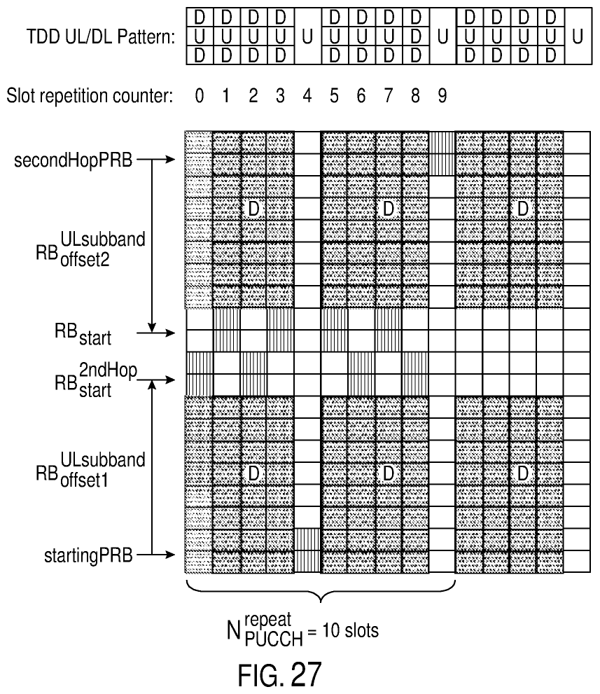

FIG. 27 depicts an example embodiment in accordance with the embodiment #C-3 (Ex1a/1b).

In at least one embodiment, the allocated RB indices for PUCCH are first determined according to the existing NR/3GPP specifications and protocols for a PUCCH transmission in UL-only symbols. For a PUCCH transmission in SBFD symbols, the allocated RB indices are further adjusted based on a first RB offset

$$R {B}_{offset 1}^{ULsubband}$$

to ensure that the starting RB falls within the UL subband.
In at least one example embodiment Ex1a, the starting RB index is determined as:

$$R {B}_{s t a r t} = startingPRB + {RB}_{offset 1}^{ULsubband}$$

In at least one example embodiment of

$$R {B}_{offset 1}^{ULsubband} = 109 ,$$

a PUCCH allocated for RB #2 (startingPRB=2) to RB #5 is transmitted in RB #111 to RB #114 (i.e., the first 4 RBs of the UL subband).
In at least one example embodiment Ex2a, the starting RB index is determined relative to the first RB of the UL subband as:

$$R {B}_{s t a r t} = R {B}_{s t a r t}^{ULsubband} + R {B}_{offset l}^{ULsubband}$$

In at least one example embodiment of

$$R {B}_{offset 1}^{ULsubband} = 2 ,$$

a PUCCH allocated for RB #0 to RB #3 (4 RB PUCCH allocation) is transmitted in RB #113 to RB #116
In at least one example embodiment Ex3a, the starting RB index is determined in the same way as Ex2a, for the case that the first RB offset is

$$R {B}_{offset 1}^{ULsubband} = startingPRB$$

If frequency hopping is configured, the allocated RB indices for the 2nd hop are further adjusted based on a second RB offset

$$R {B}_{offset 1}^{ULsubband}$$

to ensure that the starting RB falls within the UL subband.
In at least one example embodiment Ex1b, the starting RB index for the 2nd hop is determined as:

$$R {B}_{s t a r t}^{2 ndHop} = secondHopPRB - {RB}_{offset 2}^{ULsubband}$$

In at least one example embodiment of

$$R {B}_{offset 1}^{ULsubband} = 1 \; 09 , {RB}_{offset 2}^{ULsubband} = 109 ,$$

a PUCCH allocated for RB #2 (startingPRB=2) to RB #5 for the 1st hop and for RB #267 (secondHopPRB=267) to RB #270 for the 2nd hop, PUCCH is transmitted in SBFD symbols in the following RBs:
For even values of the slot repetition counter, the wireless device 22 transmits the PUCCH in RB #111 to RB #114 (i.e., the first 4 RBs of the UL subband).
For even values of the slot repetition counter, the wireless device 22 transmits the PUCCH in RB #158 to RB #161 (i.e., the last 4 RBs in the UL subband).
In at least one example embodiment Ex2b, the starting RB index for the 2nd hop is determined relative to the first RB of the UL subband as:

$$R {B}_{start}^{2 ndHop} = R {B}_{start}^{ULsubband} + R {B}_{offset 2}^{ULsubband}$$

In at least one example embodiment of

$${RB}_{offset 1}^{ULsubband} = 2 , R {B}_{offset 2}^{ULsubband} = 45 ,$$

a PUCCH allocated for RB #0 to RB #3 for the 1^{st} hop (4 RB PUCCH allocation) and for RB #269 to RB #272 for the 2^{nd} hop, PUCCH is transmitted in SBFD symbols in the following RBs:
For even values of the slot repetition counter, the wireless device 22 transmits the PUCCH in RB #113 to RB #116
For even values of the slot repetition counter, the wireless device 22 transmits the PUCCH in RB #156 to RB #159

### Explicit Signaling of Offsets:

In at least one example embodiment, the offsets

$$R {B}_{offset 1}^{ULsubband} and {RB}_{offset 2}^{ULsubband}$$

are semi-statically configured to the wireless device 22 from the network node 16, via RRC configuration or via system information transmissions.
Implicit determination of RB offsets:

In at least one example embodiment, instead of explicit signalling of the offset(s) to the wireless device 22, the wireless device 22 determines the offsets implicitly as a function of the bandwidth part size

$${N}_{BWP}^{s i z e} ,$$

UL suppand size

$${N}_{ULsubband}^{s i z e} ,$$

DL subband size(s), one or more RB indices of the PUCCH frequency domain resource allcoation, PUCCH allocation size, or any combination of these values.

In at least one example embodiment utilizing implicit determination, the wireless device 22 determines the first and second offsets as follows:

$$R {B}_{offset 1}^{ULsubband} = R {B}_{s t a r t}^{U L s ubband} - startingPRB$$

$${RB}_{offset 2}^{ULsubband} = secondHopPRB - ( {RB}_{s t a r t}^{ULsubband} + {N}_{ULsubband}^{s i z e} - {N}_{PUCCH}^{s i z e} )$$

where

$${N}_{PUCCH}^{s i z e}$$

is allocated to PUCCH. With the same numerical example as above, the wireless device 22 determines the two offsets as

$$R {B}_{offset 1}^{ULsubband} = 111 - 2 = 109 and {RB}_{offset 2}^{ULsubband} = 267 - ( 111 + 51 - 4 ) = 109 .$$

Using the above formula for the starting RB for the 1st and 2nd hops, the PUCCH in SBFD symbols is transmitted in the following RBs:
For even values of the slot repetition counter, the wireless device 22 transmits the PUCCH in RB #111 to RB #114 (i.e., the first four RBs of the UL subband).
For even values of the slot repetition counter, the wireless device 22 transmits the PUCCH in RB #158 to RB #161 (i.e., the last four RBs in the UL subband).

In at least one embodiment, though the above implicit approach involves two steps to determine the starting RB index for the 1^{st} and 2^{nd} hop (first calculate RB offsets, then calculate starting RB indices), these two steps may be collapsed into one such that the starting RB index for the 1^{st} and 2^{nd} hop are determined directly, for example from the following formulas:

$$R {B}_{s t a r t} = R {B}_{offset 1}^{ULsubband}$$

$$R {B}_{s t a r t}^{2 ndHop} = {RB}_{s t a r t}^{ULsubband} + {N}_{ULsubband}^{s i z e} - {N}_{PUCCH}^{s i z e}$$

In the above example, the first and second RB offsets may be transparent to the wireless device 22 and may depend only on the start/size of the UL subband and the size of the PUCCH allocation.

In at least one embodiment, if the two offsets may always have the same value, then it is may not be necessary to explicitly or implicitly determine two different offsets.

$$R {B}_{offset 1}^{ULsubband} and {RB}_{offet 2}^{ULsubband}$$

can be replaced by a single offset

$${RB}_{offset}^{ULsubband} .$$

Referring back to FIG. 26 there is shown an example in accordance with some embodiments where FIG. 26 shows a TDD pattern in which the first 4 slots contain an UL subband and the 5th slot is UL-only. It may be assumed that PUCCH is configured with 10 repetitions (2 cycles of the TDD pattern) and with frequency hopping. For UL-only slots 4 and 9, the starting RB and number of RBs for the 1st and 2nd hops and the RB offset for the 2^{nd} hop are determined according to the existing NR/3GPP specifications and protocols. For the SBFD slots 0, 1, 2, 3, 5, 6, 7, 8, the starting RB for the 1st and 2nd hops are determined according to the formulas in Ex1a and Ex1b above, such that they are within the UL subband.

### Embodiment #C-4 (Variable Coding Rate Across Repetitions)

In any of the Group C embodiments, the number of PRBs allocated to PUCCH

$${N}_{PUCCH}^{s i z e} ,$$

and thus the coding rate for the uplink control information (UCI), can be different in the different symbol types. For example, for repetitions in SBFD symbols, a larger number of PRBs (lower coding rate) can be allocated compared to the UL-only symbols. This can be beneficial to overcome the notions that SBFD symbols may suffer from lower SINR due to self-interference due to simultaneous DL transmissions from the same network node 16 trying to receive the PUCCH resource.

One or more embodiments described herein provide the advantage of enabling PUCCH with repetition across both SBFD and UL-only slots is that it enables the UL coverage gain for PUCCH promised by SBFD operation in which additional UL transmission opportunities are introduced by allowing the network node 16 to receive UL in simultaneously in slots that it uses for DL transmission.

### Examples

Example A1. A network node 16 configured to communicate with a wireless device 22, WD 22, the network node 16 configured to, and/or comprising a radio interface 60 and/or comprising processing circuitry 68 configured to:
determine a frequency hopping and frequency domain resource allocation, the frequency hopping and frequency domain resource allocation being configured to enable operation across slots where a number of available uplink resources in the frequency domain is different in different slots; and
indicate the frequency hopping and frequency domain resource allocation to configure the wireless device 22 to communicate using a physical uplink control channel, PUCCH, transmission with repetition.

Example A2. The network node 16 of Example A1, wherein the wireless device 22 is configured not to use frequency hopping for a PUCCH transmission in UL-only symbols.

Example A3. The network node 16 of Example A1, wherein the wireless device 22 is configured to not employ frequency hopping if the upload subband size is less than a predetermined threshold.

Example B1. A method implemented in a network node 16, the method comprising:
determining a frequency hopping and frequency domain resource allocation, the frequency hopping and frequency domain resource allocation being configured to enable operation across slots where a number of available uplink resources in the frequency domain is different in different slots; and
indicate the frequency hopping and frequency domain resource allocation to configure the wireless device 22 to communicate using a physical uplink control channel, PUCCH, transmission with repetition.

Example B2. The method of Example B1, wherein the wireless device 22 is configured not to use frequency hopping for a PUCCH transmission in UL-only symbols.

Example B3. The method of Example B1, wherein the wireless device 22 is configured to not employ frequency hopping if the upload subband size is less than a predetermined threshold.

Example C1. A wireless device 22 (WD 22) configured to communicate with a network node 16, the WD 22 configured to, and/or comprising a radio interface 82 and/or processing circuitry 84 configured to:
receive an indication of a frequency hopping and frequency domain resource allocation, the frequency hopping and frequency domain resource allocation being configured to enable operation across slots where a number of available uplink resources in the frequency domain is different in different slots; and
communicate with a network node 16 using a physical uplink control channel, PUCCH, transmission according to the frequency hopping and frequency domain resource allocation.

Example C2. The WD 22 of Example C1, wherein the wireless device 22 is configured not to use frequency hopping for a PUCCH transmission in uplink, UL, only symbols.

Example C3. The WD 22 of Example C1, wherein the wireless device 22 is configured to not employ frequency hopping if the upload subband size is less than a predetermined threshold

Example D1. A method implemented in a wireless device 22 (WD 22), the method comprising:
receiving a frequency hopping and frequency domain resource allocation, the frequency hopping and frequency domain resource allocation being configured to enable operation across slots where a number of available uplink resources in the frequency domain is different in different slots; and
communicating with a network node 16 using a physical uplink control channel, PUCCH, transmission according to the frequency hopping and frequency domain resource allocation.

Example D2. The method of Example D1, wherein the wireless device 22 is configured not to use frequency hopping for a PUCCH transmission in UL-only symbols.

Example D3. The method of Example D1, wherein the wireless device 22 is configured to not employ frequency hopping if the upload subband size is less than a predetermined threshold.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, JavaR or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A wireless device configured to communicate with a network node, the wireless device configured to:
receive control signaling for a physical uplink control channel, PUCCH, transmission; and
perform the PUCCH transmission based on the control signaling, the PUCCH transmission spanning a plurality of slots, the plurality of slots including at least one slot containing at least one uplink-only, UL-only, symbol and at least one slot containing at least one subband full duplex, SBFD, symbol, and the PUCCH transmission spans the at least one UL-only symbol and the at least one SBFD symbol.

2. The wireless device of claim 1, wherein the control signaling includes a frequency hopping configuration.

3. (canceled)

4. The wireless device of claim 1, wherein the wireless device performs at least one of intra-slot frequency hopping and inter-slot frequency hopping in the at least one SBFD symbol based on a UL subband of the at least one SBFD symbol being greater than a threshold; or
the wireless device performs at least one of intra-slot frequency hopping and inter-slot frequency hopping in the at least one UL-only symbol but does not perform frequency hopping in the at least one SBFD symbol.

5. (canceled)

6. (canceled)

7. The wireless device of claim 1, wherein the control signaling includes a first indication of a starting resource block for the PUCCH transmission, the starting resource block being within an UL resource block within an UL subband of the at least one SBFD symbol.

8. The wireless device of claim 2, wherein:
the control signaling includes a first indication and a second indication;
the first indication corresponding to a first resource block used for transmission of a starting resource block of the PUCCH transmission, the first resource block being within an UL subband of the at least one SBFD symbol; and
the second indication indicating a second resource block within the UL subband of the at least one SBFD symbol, the second resource block corresponding to a frequency hop of the PUCCH transmission.

9. The wireless device of claim 2, wherein the control signaling includes a first slot repetition counter used for at least one of intra-slot frequency hopping and inter-slot frequency hopping in the at least one SBFD symbol and a second slot repetition counter used for frequency hopping in the at least one UL-only symbol.

10. The wireless device of claim 1, wherein the control signaling includes a first resource block offset, and a starting resource block of the PUCCH transmission within an UL subband of the at least one SBFD symbol is based on the first resource block offset.

11. The wireless device of claim 10, wherein the control signaling includes a frequency hopping configuration and a second resource block offset, and a starting resource block of a second frequency hop of the PUCCH transmission within an UL subband of the at least one SBFD symbol is based on the second resource block offset.

12. (canceled)

13. The wireless device of claim 1, wherein the PUCCH transmission in the at least one UL-only symbol has a first coding rate, and the PUCCH transmission in the at least one SBFD symbol has a second coding rate, the first coding rate being different from the second coding rate.

14. A method performed by a wireless device, the method comprising:
receiving control signaling for a physical uplink control channel, PUCCH, transmission; and
performing the PUCCH transmission based on the control signaling, the PUCCH transmission spanning a plurality of slots, the plurality of slots including at least one slot containing at least one uplink-only, UL-only, symbol and at least one slot containing at least one subband full duplex, SBFD, symbol, and the PUCCH transmission spans the at least one UL-only symbol and the at least one SBFD symbol.

15.-26. (canceled)

27. A network node configured to communicate with a wireless device, the network node configured to:
transmit, to the wireless device, control signaling for a physical uplink control channel, PUCCH, transmission; and
receive the PUCCH transmission based on the control signaling, the PUCCH transmission spanning a plurality of slots, the plurality of slots including at least one slot containing at least one uplink-only, UL-only, symbol and at least one slot containing at least one subband full duplex, SBFD, symbol, and the PUCCH transmission spans the at least one UL-only symbol and the at least one SBFD symbol.

28. The network node of claim 27, wherein the control signaling includes a frequency hopping configuration.

29.-32. (canceled)

33. The network node of claim 27, wherein the control signaling includes a first indication of a starting resource block for the PUCCH transmission, the starting resource block being within an UL resource block within an UL subband of the at least one SBFD symbol.

34. The network node of claim 28, wherein:
the control signaling includes a first indication and a second indication;
the first indication corresponding to a first resource block used for transmission of a starting resource block of the PUCCH transmission, the first resource block being within an UL subband of the at least one SBFD symbol; and
the second indication indicating a second resource block within the UL subband of the at least one SBFD symbol, the second resource block corresponding to a frequency hop of the PUCCH transmission.

35. The network node of claim 28, wherein the control signaling includes a first slot repetition counter used for at least one of intra-slot frequency hopping and inter-slot frequency hopping in the at least one SBFD symbol and a second slot repetition counter used for frequency hopping in the at least one UL-only symbol.

36. The network node of claim 27, wherein the control signaling includes a first resource block offset, and a starting resource block of the PUCCH transmission within an UL subband of the at least one SBFD symbol is based on the first resource block offset.

37.-39. (canceled)

40. A method performed by a network node, the method comprising:
transmitting, to a wireless device, control signaling for a physical uplink control channel, PUCCH, transmission; and
receiving the PUCCH transmission based on the control signaling, the PUCCH transmission spanning a plurality of slots, the plurality of slots including at least one slot containing at least one UL-only symbol and at least one slot containing at least one subband full duplex, SBFD, symbol, and the PUCCH transmission spans the at least one UL-only symbol and the at least one SBFD symbol.

41.-52. (canceled)
